(19) United States
(12) Patent Application Publication
(10) Pub. No.: US 2013/0048392 A1
(43) Pub. Date: Feb. 28, 2013

(54) Dual track vehicle

(71) Applicant: Gautier Arcouette, Mansonville (CA)

(72) Inventor: Gautier Arcouette, Mansonville (CA)

(21) Appl. No.: 13/573,065

(22) Filed: Aug. 17, 2012

(30) Foreign Application Priority Data
Aug. 31, 2011 (CA) 2,751,184

(51) Int. Cl. B62D 55/06

(52) U.S. Cl. 180/9.5; 180/9.1

(57) ABSTRACT

A recreational vehicle comprising a body, a steering mechanism, a straddle seat, first and second track assemblies located in respective sides of the straddle seat, at least one motor for driving the track assemblies, and a platform for receiving the feed of a driver, the platform being located intermediate the tracks and the seat, the platform being located at a height of between 10% and 90% of the height of the tracks.

### FIELD OF THE INVENTION

The present invention relates to vehicles and more particularly relates to a dual track vehicle with a method for driving the vehicle to provide maximum stability and maneuverability.

### BACKGROUND OF THE INVENTION

The field of recreational vehicles includes many different designs. The original all terrain vehicle was designed to have a tricycle geometry and employed a small motorcycle engine to drive the two rear wheels. The machines were designed to be utilized in snow, mud and various other slippery conditions.

Upon their introduction, such vehicles were seen as being usable by farmers. In lieu of using a tractor, the all terrain vehicle could perform some of the tasks and utilized a substantially lower amount of fuel. As their popularity gained among farmers, the general public became interested in racing such vehicles. Typically they were raced on frozen lakes in the East and desert or dirt ovals in the West.

The early design of the all terrain vehicle leaned to a three-wheeled vehicle. However, production of three-wheelers ceased due to safety concern since three-wheelers were more unstable than four-wheelers. At the same time, different types of recreational vehicles were designed including tracked vehicles which could operate in conditions which could not be handled by traditional wheeled vehicles. A number of different designs have been proposed in the art.

A prime advantage of a tracked vehicle compared to wheeled vehicles is that it is in contact with a larger surface area than would generally be the case with a wheeled vehicle. As a result, they exert a much lower force per unit area on the substrate being traversed than a conventional wheeled vehicle of the same weight. As such, they are more suitable for use on soft, low friction and uneven ground such as mud, ice and snow.

### SUMMARY OF THE INVENTION

It is an object of the present invention to provide a dual track vehicle which has a high degree of stability and provides for comfortable positioning of the driver of the vehicle.

According to one aspect of the present invention, there is provided a multi purpose vehicle comprising a body, a steering mechanism, a seat, first and second track assemblies located on respective sides of the seat, a motor for driving the tracks, a platform for receiving the feet of a driver, the platform being located intermediate the tracks and the seat, the platform being located at a height of between 10% and 90% of the height of the tracks and even more preferably, between 25% and 75% of the height of the tracks.

As set forth above, the multi purpose vehicle of the present invention is a tracked vehicle (i.e. it is driven by a track which in turn is driven by one or more wheels which engage and drive the track). Such arrangements are well known in the art.

Preferably the vehicle is powered by one motor and the speed of each track is controlled by a well known arrangement such as a triple differentials transmission. However, each track can be driven independently with its own motor.

The vehicle has a straddle seat arrangement. Conveniently, many of the components of the multi purpose vehicle such as the motors, steering mechanism, muffler, fuel tank, battery, transmission, etc, may be located under the straddle seat with easy access being had thereto.

The steering bar is preferably positioned such that when the driver sits or stands on the vehicle, the feet of the driver are disposed between the tracks and the straddle seat. It is a preferred arrangement that the suspensions (both sides) are positioned such that the driver's feet rest lower than the highest points of the track. When sitting, the seating is such that the driver's knees are disposed in front of the driver's ankle and below the driver's hips. This positioning allows for a more comfortable driving experience since the driver can easily stand up to absorb shocks by flexing his knees and also better balance the vehicle.

In a preferred embodiment, the track assemblies each comprise a track with a plurality of cleats extending outwardly therefrom.

The cleats will generally extend across the width of the track. Preferably, the cleats will have an arcuate outer edge.

A plurality of smaller cleats may be mounted on the inner side of the track near the outer edge thereof. These cleats will help provide for better clearing of the snow between the cleats and permits the expulsion of the snow sideways.

### BRIEF DESCRIPTION OF THE DRAWINGS

Having thus generally described the invention, reference will be made to the accompanying drawings, illustrating an embodiment of the invention, in which:

FIG. 1 is a perspective view of a vehicle according to one embodiment of the present invention;

FIG. 2 is a front elevational view of the vehicle of FIG. 1; and

FIG. 3 is a side elevational view of the vehicle as seen from the left hand side of FIG. 2.

### DETAILED DESCRIPTION OF THE INVENTION

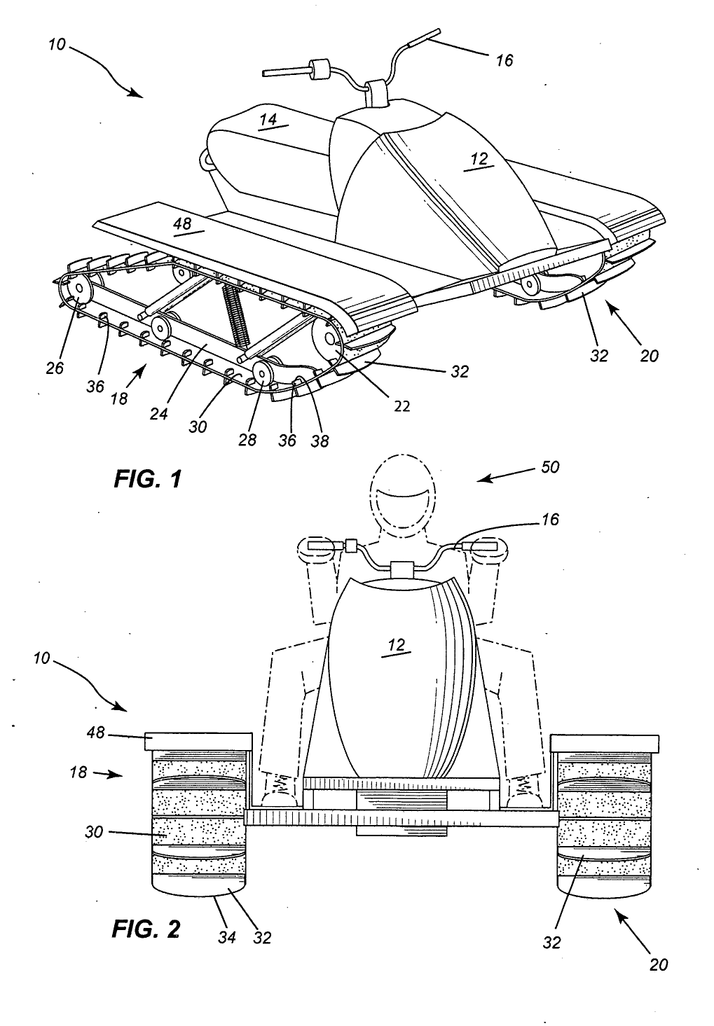

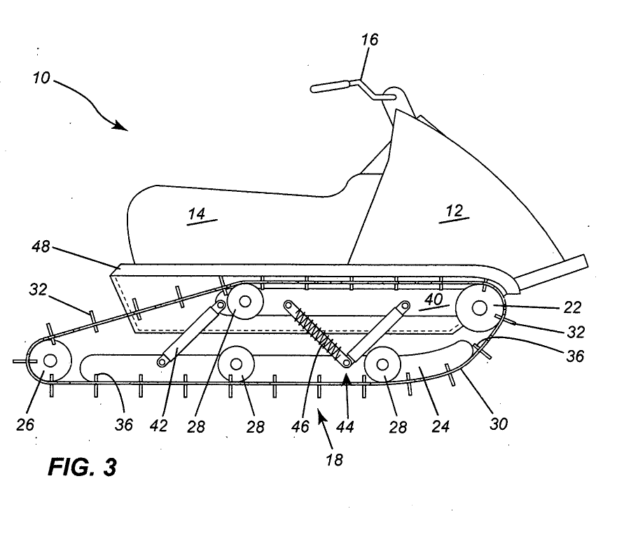

Referring to the figures in greater detail and by reference characters thereto, there is illustrated in FIG. 1 a vehicle which is generally designated by reference numeral 10. Vehicle 10 includes a housing generally designated by reference numeral 12. Situated rearwardly of housing 12 is a side seat 14. Handle bars 16 are associated with a steering mechanism for handling the vehicle.

The vehicle includes a first track assembly 18 situated on the right hand side of the vehicle and a second track assembly 20 situated on the left side of the vehicle. As first track assembly 18 and second track assembly 20 are substantially identical, only first track assembly 18 will be described herein.

First track assembly 18 includes a drive wheel 22 operatively connected to the motor (not shown) in a conventional manner. A lower guide bar 24 extends longitudinally of the machine in a conventional arrangement. A rear idler wheel or roller 26 is mounted to entrain the track 30 thereabout. A plurality of intermediate idler wheels or rollers 28 are provided in a conventional manner.

Track 30 includes a plurality of outer cleats 32 which extend transversally across the track. Outer cleats 32 are provided with an arcuate outer edge 34. Mounted on the inner side of the track are a set of cleats 36. Cleats 36 are relatively narrow in width and likewise include an arcuate upper edge 38.

Vehicle 10 also includes two upper pivot points on each side firmly attached to the frame and or bottom platform 40 and a double pivot link 42 extends between the two upper pivot points 40 and lower guide bar 24 preferably the links are arranged at an angle to maximize vertical movement and minimize horizontal movement; in a preferred arrangement the rear link is slightly longer or positioned in such a manner that the angle is different. This arrangement prevents the vehicle from leaning forward when suspension is compressed. Similarly, there is provided a suspension 44 extending between frame and or bottom platform 40 and lower guide bar 24. A spring and a shock absorber 46 forms part of suspension. 44.

A fender 48 is mounted in a conventional manner above track 30.

It will be understood that the above described embodiment is for purposes of illustration only and that changes and modifications may be made thereto without departing from the spirit and scope of the invention.

I claim:

1. A recreational vehicle comprising:
a body;
a steering mechanism;
a seat;
first and second track assemblies located on respective sides of the seat;
a motor for driving said tracks;
a platform for receiving the feet of a driver, said platform being located intermediate said tracks and said seat, said platform being located at a height of between 10% and 90% of the height of said tracks.

2. The multi purpose vehicle of claim 1 wherein said track assemblies each comprise a track and a plurality of cleats extending outwardly therefrom.

3. The recreational vehicle of claim 2 wherein each track has a inner set of cleats and an outer set of cleats, the outer set of cleats being located on an outer edge of said track.

4. The recreational vehicle of claim 3 wherein said first set of cleats and said second set of cleats are offset with respect to each other.

5. The recreational vehicle of claim 4 wherein at least one set of said cleats has an arcuate outer edge.

6. The recreational vehicle of claim 5 wherein all of said cleats have an arcuate outer edge to assist in providing an enhanced traction forwardly and a minimum of friction sideways to facilitate turning.

7. The recreational vehicle of claim 6 further including a suspension associated with each track assembly.
